(19) United States
(12) Patent Application Publication
(10) Pub. No.: US 2020/0258478 A1
(43) Pub. Date: Aug. 13, 2020

(54) PROGRAMMABLE GLASS DISPLAY

(71) Applicant: GM Global Technology Operations LLC, Detroit, MI (US)

(72) Inventors: Julien P. Mourou, Bloomfield Hills, MI (US); Craig A. Kollar, Sterling Heights, MI (US); David G. Meller, Shelby Township, MI (US); Richard Zeldes, Ortonville, MI (US)

(21) Appl. No.: 16/272,564

(22) Filed: Feb. 11, 2019

(51) Int. Cl. G09G 5/36; B60R 11/02; G06K 7/14; G06K 7/10; G06K 19/06

(52) U.S. Cl. CPC G09G 5/36; B60R 11/0235; G06K 7/1417; B60R 2011/004; G06K 19/06037; G09G 2380/10; G06K 7/10722

(57) ABSTRACT

A display assembly includes a first rigid layer, a first adhesive layer disposed adjacent to the first rigid layer, a second rigid layer, a second adhesive layer disposed adjacent to the second rigid layer, a display screen disposed between the first adhesive layer and the second adhesive layer, the display screen having a first side facing an exterior of the display assembly and a second side facing an interior of the display assembly, and a controller that is in communication with the display screen to generate a pattern on the display screen visible from the exterior of the display assembly.

The present disclosure relates generally to electronic display devices with transparent display capabilities. More specifically, aspects of this disclosure relate to a laminated-glass transparent display unit for a vehicle window.

Most current production motor vehicles, such as the modern-day automobile, are erected on a rigid vehicle body—either as a body-on-frame or a unibody construction—with an interior passenger compartment that seats and safeguards the vehicle occupants. In automotive applications, the front wind shield, the rear window and side windows prevent the unwanted ingress of wind, rain, and debris. Modern windshields, side and rear windows are generally formed as a laminated glass construction—a multi-layer assembly with a plastic interlayer, typically of polyvinyl butyral (PVB) or ethylene-vinyl acetate (EVA), which is laminated between two or more curved sheets of tempered glass.

To help increase driver awareness of vehicle systems operation and ambient driving conditions, some modern vehicles supplement the dashboard instrument panel and the center console touchscreen display with a heads-up display (HUD) device that projects light onto an aft surface of the front windshield to create a viewable display of information. Alternative HUD configurations employ a dashboard-mounted “see through” display device, which employs light emitting diode (LED) or liquid crystal display (LCD) technologies to provide fully or partially transparent display capabilities. Irrespective of which technique is employed, an automotive HUD is designed to present information within the operator's forward-driving field of view and, thus, reduce superfluous eye scanning and glance behavior at the instrument panel and center console. These displays, however, do not provide the status of the vehicle or enable a user of the vehicle to interact with the vehicle from the exterior of the vehicle.

Thus, while current window displays achieve their intended purpose, there is a need for a new and improved system and method for communicating information between a user of a vehicle and the vehicle with window displays.

### SUMMARY

According to several aspects, a display assembly includes a first rigid layer, a first adhesive layer disposed adjacent to the first rigid layer, a second rigid layer, a second adhesive layer disposed adjacent to the second rigid layer, a display screen disposed between the first adhesive layer and the second adhesive layer, the display screen having a first side facing an exterior of the display assembly and a second side facing an interior of the display assembly, and a controller that is in communication with the display screen to generate a pattern on the display screen visible from the exterior of the display assembly.

In an additional aspect of the present disclosure, the first rigid layer is less than 70% transparent and the second rigid layer is less than 70% transparent.

In another aspect of the present disclosure, the first rigid layer and the second rigid layer are made of glass.

In another aspect of the present disclosure, the display screen display screen includes a reflective material.

In another aspect of the present disclosure, the display screen includes a polymer film.

In another aspect of the present disclosure, the polymer film includes a first layer for emission of a first color of the visible spectrum and a second layer for emission of a second color of the visible spectrum.

In another aspect of the present disclosure, the display screen includes a trans-flective material.

In another aspect of the present disclosure, the display screen generates an identifier.

In another aspect of the present disclosure, the identifier is scannable with a mobile device.

In another aspect of the present disclosure, the identifier provides status.

In another aspect of the present disclosure, the identifier provides instructions to a user interfacing with the display assembly.

According to several aspects, a motor vehicle includes a cabin, a controller, and a display assembly with a display screen visible from an exterior of the motor vehicle. The display assembly includes a first rigid layer, a first adhesive layer disposed adjacent to the first rigid layer, a second rigid layer, a second adhesive layer disposed adjacent to the second rigid layer, the display screen being disposed between the first adhesive layer and the second adhesive layer. The controller is in communication with the display screen to generate a pattern on the display screen visible from the exterior of the motor vehicle.

In another aspect of the present disclosure, the display screen generates an identifier.

In another aspect of the present disclosure, the identifier is scannable with a mobile device.

In another aspect of the present disclosure, the identifier provides status of the motor vehicle.

In another aspect of the present disclosure, the identifier provides instructions to a user of the motor vehicle.

According to several aspects, a method of translating an image into a programmable zero power image one or more of the following: uploading the image as a digital asset with a web application; translating the digital asset to a load script; downloading the load script to a processing unit; and executing the load script with the processing unit to form a zero power image, the zero power image being displayed on a display screen of a display assembly, the zero power image being visible to an exterior of the display assembly.

In another aspect of the present disclosure, the display screen generates an identifier.

In another aspect of the present disclosure, the identifier provides status.

In another aspect of the present disclosure, the identifier provides instructions to a user interfacing with the display assembly.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle according to an exemplary embodiment;

FIG. 2 is a schematic view of a laminated display assembly according to an exemplary embodiment;

FIG. 3 is a schematic view of an alternative laminated display assembly according to an exemplary embodiment;

FIG. 4 is flowchart representation of a method according to an exemplary embodiment;

FIG. 5 illustrates a use of a laminated display assembly according to an exemplary embodiment;

FIG. 6 illustrates a laminated display assembly providing bar codes according to an exemplary embodiment;

FIG. 7 is a block diagram illustrating a method of translating an image into a programmable zero power image according to an exemplary embodiment; and

FIG. 8 is a schematic view of yet another alternative laminated display assembly according to an exemplary embodiment

### DETAILED DESCRIPTION

The following description is merely exemplary in nature and is not intended to limit the present disclosure, application, or uses.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

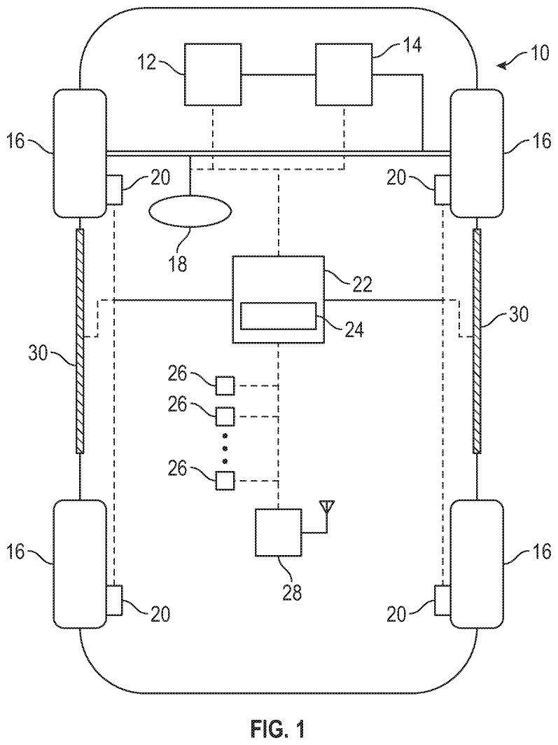

Referring now to FIG. 1, an automotive vehicle 10 according to the present disclosure is shown in schematic form. The automotive vehicle 10 includes a propulsion system 12, which may in various embodiments include an internal combustion engine, an electric machine such as a traction motor, and/or a fuel cell propulsion system.

The automotive vehicle 10 also includes a transmission 14 configured to transmit power from the propulsion system 12 to vehicle wheels 16 according to selectable speed ratios. According to various embodiments, the transmission 14 may include a step-ratio automatic transmission, a continuously-variable transmission, or other appropriate transmission.

The automotive vehicle 10 additionally includes a steering system 18. While depicted as including a steering wheel for illustrative purposes, in some embodiments contemplated within the scope of the present disclosure, the steering system 18 may not include a steering wheel.

The automotive vehicle 10 additionally includes a plurality of vehicle wheels 16 and associated wheel brakes 20 configured to provide braking torque to the vehicle wheels 16. The wheel brakes 20 may, in various embodiments, include friction brakes, a regenerative braking system such as an electric machine, and/or other appropriate braking systems.

The propulsion system 12, transmission 14, steering system 18, and wheel brakes 20 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 is provided with an automated driving system (ADS) 24 for automatically controlling various actuators in the vehicle 10. In an exemplary embodiment, the ADS 24 is configured to control the propulsion system 12, transmission 14, steering system 18, and wheel brakes 20 to control vehicle acceleration, steering, and braking, respectively, without human intervention.

The ADS 24 is configured to control the propulsion system 12, transmission 14, steering system 18, and wheel brakes 20 in response to inputs from a plurality of sensors 26, which may include GPS, RADAR, LIDAR, optical cameras, thermal cameras, ultrasonic sensors, and/or additional sensors as appropriate.

The vehicle 10 additionally includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, additional or alternate wireless communications standards, such as IEEE 802.11 and cellular data communication, are also considered within the scope of the present disclosure.

In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

The vehicle 10 additionally includes at least one multi-view display 30, which will be discussed in further detail below. In the embodiment of FIG. 1, the vehicle 10 includes multi-view displays 30 on sides of the vehicle 10, e.g. in locations generally corresponding to traditional side windows. However, in other embodiments, different numbers of multi-view displays 30 may be included. Multi-view displays 30 may also be provided in different vehicle locations, such as at a front portion of the vehicle 10 corresponding to a traditional windshield, a rear portion of the vehicle 10 corresponding to a traditional rear window, a top portion of the vehicle 10 corresponding to a traditional sunroof, or any other location of the vehicle. The multi-view display or displays 30 are in communication with or under the control of the controller 22.

When a vehicle with an automated driving system is operated in an autonomous mode of operation, occupants in the vehicle may desire to view images, videos, text, or other visual patterns rather than viewing the outside of the vehicle.

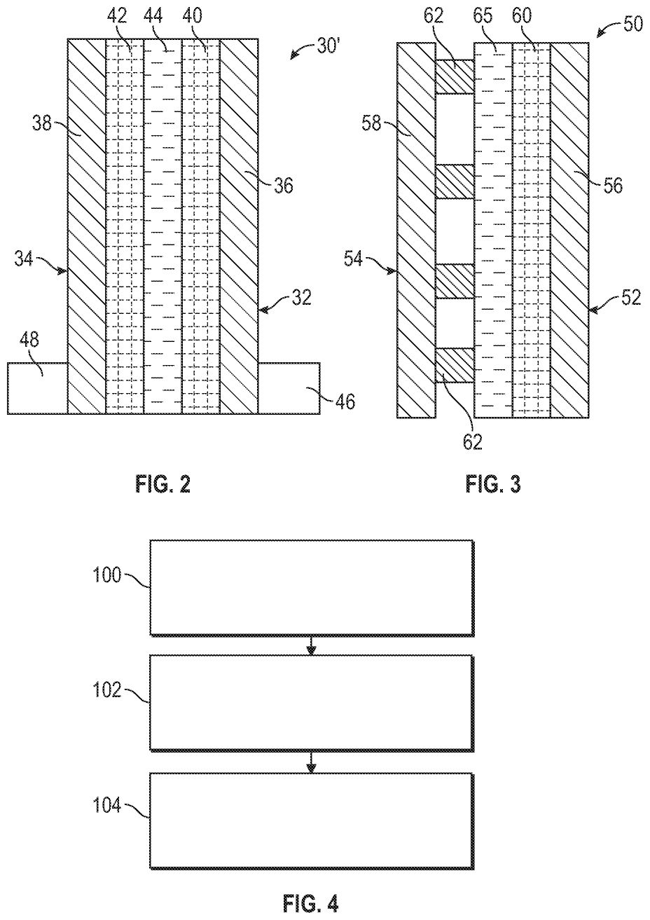

Referring now to FIG. 2, a multi-view display 30′ is shown. The multi-view display 30′ includes a plurality of laminated layers as will be discussed in further detail below. The multi-view display 30′ may be implemented in a vehicle in similar fashion as the multi-view display 30 depicted in FIG. 1.

The multi-view display 30′ has a first side 32 and a second side 34. In an exemplary embodiment, the first side 32 faces an interior portion of a vehicle, which may be referred to as a cabin, while the second side 34 faces an exterior of the vehicle. The multi-view display 30′ has a first imaging display surface visible on the first side 32 and a second imaging display surface visible on the second side 34.

The multi-view display 30′ includes a first rigid layer 36 on the first side 32 and a second rigid layer 38 on the second side 34. The rigid layers 36 and 38 may, in various embodiments, include tempered glass, polycarbonate, or other rigid materials having desirable light transmissive properties. In automotive implementations the rigid layers 36 and 38 may be at least 70% transparent; however, in other implementations other light transmissive ranges may be desirable.

The multi-view display 30′ also includes a first display interlayer 40 proximate the first rigid layer 36, a second display interlayer 42 proximate the second rigid layer 38, and a blocking interlayer 44 disposed between the first display interlayer 40 and the second display interlayer 42. A first energy source 46 is provided on the first side 32 and a second energy source 48 is provided on the second side 34. In an exemplary embodiment, the first energy source 46 includes a first ultraviolet laser and the second energy source 48 includes a second ultraviolet laser.

The first and second display interlayers 40 and 42 may each comprise one or more respective layers of polymer film provided with a fluorescent material. The polymer film may be, for example, polyvinyl butyral (“PVB”), while the fluorescent material may be, for example, a phosphor. In response to ultraviolet radiation, the fluorescent material emits light in the visible spectrum. The first energy source 46 may be controlled to emit ultraviolet radiation to one or more discrete portions of the first display interlayer 40, such that fluorescent material in the one or more discrete portions emits light to form a pattern. Likewise, the second energy source 48 may be controlled to emit ultraviolet radiation to one or more discrete portions of the second display interlayer 42, such that fluorescent material in the one or more discrete portions emits light to form a pattern.

The first display interlayer 40 may include multiple layers of polymer film, each layer having respective fluorescent materials which emit different colors of visible light, e.g. red, blue, and green. In such an embodiment, the first energy source 46 may be controlled to selectively emit radiation to respective layers of polymer film in the first display interlayer 40 to form a composite pattern comprising multiple colors of visible light, e.g. by varying wavelength of the first energy source 46. The second display interlayer 42 may similarly include multiple layers of polymer film, and the second energy source 48 may be similarly controlled to form a composite pattern comprising multiple colors of visible light on the second display interlayer 42.

The first energy source 46 may be controlled to generate a first pattern on the first display interlayer 40 and the second energy source 48 may be controlled to generate a second pattern on the second display interlayer 42. The first pattern may include an image, text, video, icon, combination thereof, or any other desired pattern. The second pattern may similarly include an image, text, video, icon, combination thereof, or any other desired pattern. The first energy source 46 may be controlled independently from the second energy source 46 to produce a first pattern different from the second pattern, such that a viewer observing the first side 32 perceives a different pattern from a viewer observing the second side 34.

In an alternative embodiment, the first display interlayer 40 includes a first transparent LCD display, with a first light cavity disposed between the first transparent LCD display and the blocking interlayer 44, and the second display interlayer 42 includes a second transparent LCD display, with a second light cavity disposed between the second transparent LCD display and the blocking interlayer 44. The first energy source 46 may be controlled to provide light to the first light cavity, and the second energy source 48 may be controlled to provide light to the second light cavity. In such embodiments, the first transparent LCD display may be controlled to generate a first pattern and the second transparent LCD display may be controlled to generate a second pattern, distinct from the first pattern.

In other embodiments, the first display interlayer 40 and second display interlayer 42 may include other display technologies as appropriate. In some embodiments, the first display interlayer 40 includes a first display technology and the second display interlayer 42 includes a second display technology, different from the first display technology. Viewing experiences may thereby be optimized for viewers on different sides of the multi-view display 30′.

The blocking layer 44 is configured to inhibit energy transmission from the first display interlayer 40 to the second display interlayer 42. In an exemplary embodiment, the blocking layer 44 is formed of an ultraviolet-blocking material such that it blocks energy transmission under all operating conditions. In alternative embodiments, the blocking layer 44 is configured to selectively inhibit energy transmission. In such embodiments, the blocking layer 44 may include an LCD shutter, microshutters, an electrochromic film, an electrophoretic display, a suspended particle device, or other appropriate mechanisms for selectively inhibiting transmission of energy from the first display interlayer 40 to the second display interlayer 42.

Referring now to FIG. 3, an exemplary embodiment of a multi-view display 50 having differing display technologies is illustrated. The multi-view display 50 has a first side 52 and a second side 54. In an exemplary embodiment, the first side 52 faces an interior portion of a vehicle, which may be referred to as a cabin, while the second side 54 faces an exterior of the vehicle. The multi-view display 50 has a first imaging display surface visible on the first side 52 and a second imaging display surface visible on the second side 54.

The multi-view display 50 includes a first rigid layer 56 on the first side 52 and a second rigid layer 58 on the second side 54, which may be generally similar to the rigid layers 36 and 38 illustrated in FIG. 2. The multi-view display 50 also includes a first display interlayer 60 proximate the first rigid layer 56, a second display interlayer 62 proximate the second rigid layer 58, and a blocking interlayer 64 disposed between the first display interlayer 60 and the second display interlayer 62. The first display interlayer 60 includes a transparent OLED display, and the second display interlayer 62 includes an array of unidirectional LEDs defining a dot matrix display visible from the second side 54. The first display interlayer 60 and second display interlayer 62 may be independently controlled to generate a first pattern on the first display interlayer 60 and a second pattern on the second display interlayer 62, generally as described above with respect to FIG. 2.

Advantageously, in such an embodiment, the first display interlayer 40 may provide a high quality viewing experience for an occupant of a vehicle, while the second display interlayer 42 may provide a bright and easily visible display on the exterior of the vehicle.

Referring now to FIG. 4, a method according to the present disclosure is illustrated in flowchart form. A multi-view display is provided, as illustrated at block 100. The multi-view display includes a first rigid layer, first polymer film, a blocking layer, a second polymer film, and a second rigid layer. A first UV energy source and a second UV energy source are provided, as illustrated at block 102. A first pattern is generated on the first film and a second pattern is generated on the second film, as illustrated at block 104. The first pattern and second pattern may be distinct.

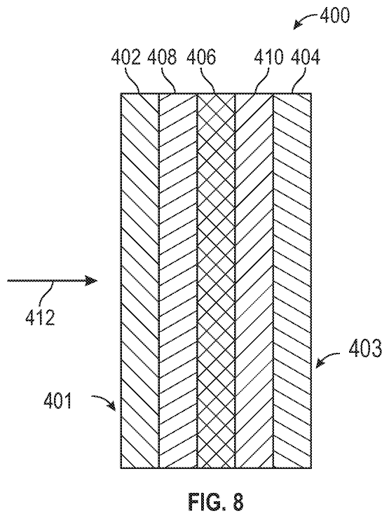

Referring now to FIG. 8, an alternative display assembly 400 is shown. The display assembly includes a plurality of laminated layers as will be discussed in further detail below. The alternative display assembly 400 may be implemented in a vehicle in similar fashion as the multi-view display 30 depicted in FIG. 1.

The display assembly 400 has a first side 401 and a second side 403. In an exemplary embodiment, the first side 401 faces an exterior portion of a vehicle, while the second side 402 faces the interior or cabin of the vehicle. The display assembly 400 has an imaging display screen 406 visible on the first side 401 from the exterior of the vehicle, as indicated by the arrow 412, which shows the line of sight of a person situated outside the vehicle.

The display assembly 400 includes a first rigid layer 402 on the first side 401 and a second rigid layer 404 on the second side 403. The rigid layers 402 and 404 include, in various arrangements, tempered glass, polycarbonate, or other rigid materials having desirable light transmissive properties. In automotive implementations the rigid layers 402 and 404 may be at least 70% transparent; however, in other implementations other light transmissive ranges are desirable. For example, certain glazing elements can be less than 70% pending on the vehicle type, location on vehicle or country requirements. Note, further, that the display assembly is not limited to glazing application and can be used in plastic appliques as well.

The display screen 406 is attached to the first rigid layer 402 with a first adhesive layer 408 and is attached to the second rigid layer 404 with a second adhesive layer 410. In various arrangements, the display screen 406 includes one or more layers of a reflective trans-flective material. The reflective material is generally bi-stable and utilizes power when switching states or to pulse energy to hold a state in intermitted intervals, which is unlike photo emitting devices that need to create light. Hence, in various arrangements, the display screen does not emit light but, rather, manipulates the ambient or focused light from another source and reflects the desired controlled color. Hence, the display screen 406 enables the communication surface to behave like vehicle paint or a sticker or vehicle wrap but with the exception that the reflective surface is programmable, as described below, and thus reusable for different purposes. The reflective material is formed from in various arrangements, but is not limited to, materials that are electrophoretic, bistable nematic, electrochomic, bi-stable electrochromics, plasmonics, bi-stable electrochromic polymers, cholesteric LC, electro-wetting, constructive/destructive interference reflective micro mirror devices, or ink particles between conductive patterned plates. In some arrangements, each reflective layer emits different colors of visible light, for example, red, blue, green, magenta, yellow, and cyan. In some arrangements, an energy source communicates with the display screen 406. In particular arrangements, the display screens generates a pattern. The pattern may include an image, text, video, icon, combination thereof, or any other desired pattern.

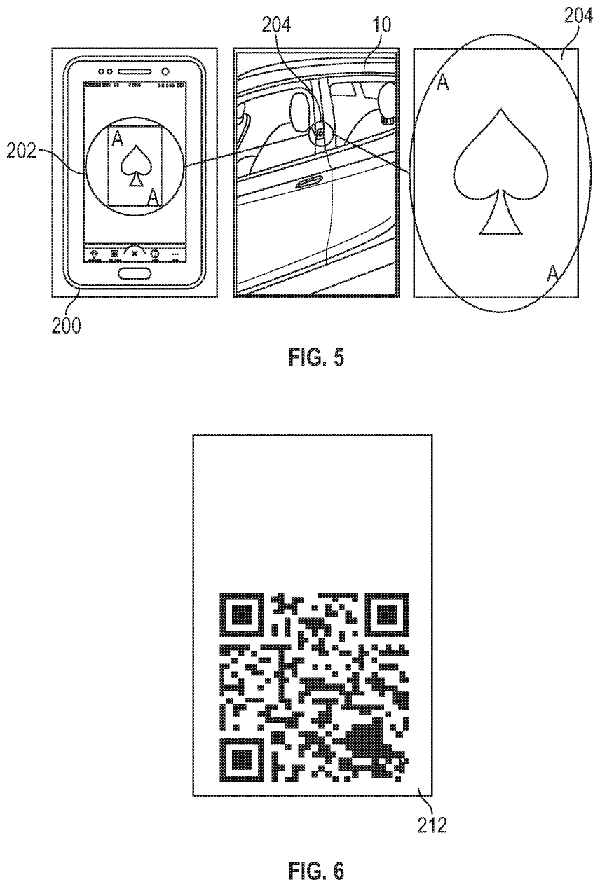

In various arrangements, the pattern generated by the display screen 406 may appear as shown on the vehicle 10 as a pattern 204 in FIG. 5. The pattern 204, in various arrangements, is communicated to, for, example, a mobile device 200 as a pattern 202. As described below, this pattern, in certain arrangements, communicates the status of the vehicle 10. In various arrangements, the pattern is a bar code 212, as shown in FIG. 6, which in some arrangements is scanned, for example, by a mobile device.

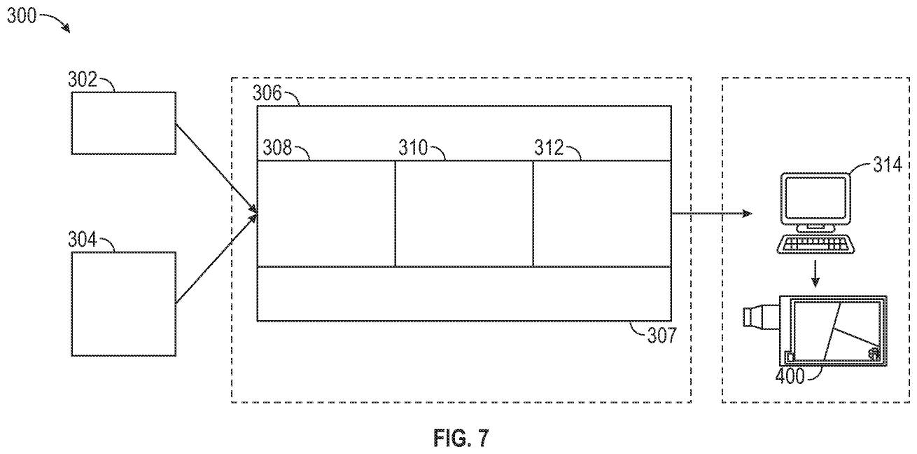

In particular arrangements, the display assembly 400 is a zero power image generated with a process 300 shown in FIG. 7. The process 300, in various arrangements, is utilized with the multi-view displays 30, 30′ and 50, as well. In certain arrangements, the process 300 uploads an image 302, and possibly additional related images 304 such as animations with an upload feature 308 of a web application 310 into digital assets. The digital assets 308 are managed 307 and then translated into a load script 310. The load script is then downloaded 312 to a processing unit 314. The processing unit executes the load to form a zero power image on the display screen 406 of the display assembly 400.

In some arrangements, the display screen generates an identifier. The identifier can provide the status of the vehicle or in other arrangements provides instructions to a user of the vehicle. Note that any of the arrangements described above are not limited to motor vehicles. The multi-view displays can be implemented in nonautomotive fields, including but not limited to, buses, ships and airplanes. Moreover, the multi-view displays may be provided, for example, as an advertising display capable of displaying differing advertisements on different sides, or as a bus stop display capable of displaying messaging pertinent to passengers on an interior side and an advertisement on an exterior side. In sum, the multi-view displays described above can be implemented in any application with glass to display information to anyone viewing the glass.

Further, the display screen provides a reflective or trans-flective communication devices integrated into the outside of a vehicle or pointing toward pedestrians, potential ride hailing customers, vulnerable road users or other road users or by-standers for displaying information or advertisement that does not fall into current lighting requirements for signaling vehicle travel intentions.

In various arrangements, the identifier:

1. Indicates the vehicle is a rental or shared vehicle, while customizable graphics protects the user's identity.

2. Utilizes QR/DM codes as an entry key to verify the correct user is entering the vehicle and other vehicle-to-customer direct communication.

3. Provides customer greetings.

4. Provides customized information, for example:

A. First responder information

B. School Logo's

C. Baby on board electronic bumper-sticker.

5. Displays state of the vehicle as a user approaches the vehicle, such as:

A. Mileage

B. Washer fluid level

C. Fuel level

D. Battery charge

E. Tire Pressure

F. Oil Life

6. Displays on-board usage instruction and troubleshooting, such as:

A. Instructions to unlock, enter, and use the vehicle

B. Lift-gate sensor doesn't open, so display provides instructions to function

C. Power doors don't open, so display troubleshooting possibilities.

7. Provides brand identification and hiding, that is, display name of a rental car company at the rental car lot, but then hide the brand when you're out-and-about to minimize the attraction of rental cars to vandals/burglars.

8. Provides visual long-distance identification of a shared vehicle so user can find it among other shared vehicles.

9. Provides advertising space.

10. Broadcasts safety instructions on emergency vehicles.

A display assembly of the present disclosure offers several advantages. These include:

1. A heated display that wakes-up and rapidly melts away snow cover over the display so you can immediately start using it.

2. Rental/Fleet providers can use the scanned QR/DM code to read-in the state of vehicle into database and flag it for service upon return instead of going into the car to get the stats.

3. The zero-to-low power of the display screen is a benefit for electric vehicles.

4. No photon emission meets with regulatory requirements for vehicles while travelling.

5. Bi-stable image is retained without power consumption.

6. Semi-transparent capable, so one can see through the display when embedded on a vehicle glass.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A display assembly comprising:
a first rigid layer;
a first adhesive layer disposed adjacent to the first rigid layer;
a second rigid layer;
a second adhesive layer disposed adjacent to the second rigid layer;
a display screen disposed between the first adhesive layer and the second adhesive layer, the display screen having a first side facing an exterior of the display assembly and a second side facing an interior of the display assembly; and
a controller that is in communication with the display screen to generate a pattern on the display screen visible from the exterior of the display assembly.

2. The display assembly of claim 1, wherein the first rigid layer is less than 70% transparent and the second rigid layer is less than 70% transparent.

3. The display assembly of claim 1, wherein the first rigid layer and the second rigid layer are made of glass.

4. The display assembly of claim 1, wherein the display screen display screen includes a reflective material.

5. The display assembly of claim 1, wherein the display screen includes a polymer film.

6. The display assembly of claim 5, wherein the polymer film includes a first layer for emission of a first color of the visible spectrum and a second layer for emission of a second color of the visible spectrum.

7. The display assembly of claim 1, wherein the display screen includes a trans-flective material.

8. The display assembly of claim 1, wherein the display screen generates an identifier.

9. The display assembly of claim 8, wherein the identifier is scannable with a mobile device.

10. The display assembly of claim 8, wherein the identifier provides a status.

11. The display assembly of claim 8, wherein the identifier provides instructions to a user interfacing with the display assembly.

12. A motor vehicle comprising:
a cabin;
a controller; and
a display assembly with a display screen visible from an exterior of the motor vehicle, the display assembly including:
a first rigid layer;
a first adhesive layer disposed adjacent to the first rigid layer;
a second rigid layer; and
a second adhesive layer disposed adjacent to the second rigid layer, the display screen being disposed between the first adhesive layer and the second adhesive layer,
wherein the controller is in communication with the display screen to generate a pattern on the display screen visible from the exterior of the motor vehicle.

13. The motor vehicle of claim 12, wherein the display screen generates an identifier.

14. The motor vehicle of claim 13, wherein the identifier is scannable with a mobile device.

15. The motor vehicle of claim 14, wherein the identifier provides status of the motor vehicle.

16. The motor vehicle of claim 14, wherein the identifier provides instructions to a user of the motor vehicle.

17. A method of translating an image into a programmable zero power image, the method comprising:
uploading the image as a digital asset with a web application;
translating the digital asset to a load script;
downloading the load script to a processing unit; and
executing the load script with the processing unit to form a zero power image, the zero power image being displayed on a display screen of a display assembly, the zero power image being visible to an exterior of the display assembly.

18. The method of claim 17, wherein the display screen generates an identifier.

19. The method of claim 18, wherein the identifier provides a status.

20. The method of claim 18, wherein the identifier provides instructions to a user interfacing with the display assembly.
